(19) United States
(12) Patent Application Publication
(10) Pub. No.: US 2023/0013342 A1
(43) Pub. Date: Jan. 19, 2023

(54) Secure Garage Space and Amenities For Rental Lodging

(71) Applicant: PB Ventures, LLC, Lenoir City, TN (US)

(72) Inventors: Tim Keeble, Lenoir City, TN (US); Christopher Keeble, Lenoir City, TN (US); Renee Sarten, Lenoir City, TN (US)

(21) Appl. No.: 17/683,780

(22) Filed: Mar. 1, 2022

Related U.S. Application Data
(60) Provisional application No. 63/155,019, filed on Mar. 1, 2021.

(51) Int. Cl. E04H 6/42; E04H 6/02; B01D 17/02; B01D 21/02; C02F 1/40

(52) U.S. Cl. CPC E04H 6/428; E04H 6/02; B01D 17/0208; B01D 21/10; C02F 1/40; B60L 53/00

(57) ABSTRACT

A garage space system for lodge guests, the system including one or more enclosable garage spaces each having a securable garage door, a drainage portion configured to drain liquid out of the one or more garage spaces, and a water supply configured to supply water for washing vehicles inside the respective one or more garage spaces.

### CROSS-REFERENCE TO RELATED APPLICATIONS

This application claims the benefit of U.S. Provisional Patent Application Ser. No. 63/155,019, filed on Mar. 1, 2021, which is incorporated herein in its entirety by reference.

### FIELD OF INVENTION

The present general inventive concept relates to rental lodge accommodations, and, more particularly, to multi-purpose automobile and/or boat accommodations provided with rental lodging.

### BACKGROUND

Typically, motor lodges provide open outdoor parking in close proximity to a room assigned to the guest. However, in many situations a guest may desire to have more secure accommodations for a car and/or other types of recreational vehicles, such as boats. Especially in the case of boats, the recreational vehicle may be equipped with many accoutrements that an owner would rather not have out in the open, and would be very inconvenient to gather and move to the guest room. Additionally, boats and other types of vehicle may be in need of various types of maintenance or general upkeep that is not convenient to perform in an open parking lot situation. Therefore, more private and easily accessible parking for such vehicles, and additional upkeep features provided in such parking, would be desirable.

### BRIEF SUMMARY

According to various example embodiments of the present general inventive concept, a garage space system is provided in which a guest is provide with a secure and enclosable space for a recreational vehicle, and many vehicle related features are provided therein to allow the user to perform cleaning, maintenance, repair, etc.

Additional aspects and advantages of the present general inventive concept will be set forth in part in the description which follows, and, in part, will be obvious from the description, or may be learned by practice of the present general inventive concept.

The foregoing and/or other aspects and advantages of the present general inventive concept may be achieved by providing a garage space system for lodge guests, the system including one or more enclosable garage spaces each having a securable garage door, a drainage portion configured to drain liquid out of the one or more garage spaces, and a water supply configured to supply water for washing vehicles inside the respective one or more garage spaces.

Other features and aspects may be apparent from the following detailed description, the drawings, and the claims.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 illustrates a garage space system for lodge guests according to an example embodiment of the present general inventive concept;

FIG. 2 illustrates a perspective view of a portion of a garage space according to an example embodiment of the present general inventive concept;

FIG. 3 illustrates a garage space system for lodge guests according to another example embodiment of the present general inventive concept;

FIG. 4 illustrates a perspective view of a portion of one of the garage spaces illustrated in FIG. 3; and

FIG. 5 illustrates a garage space system attached to a lodge according to an example embodiment of the present general inventive concept.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

According to various example embodiments of the present general inventive concept, a garage space system is provided in which a guest is provide with a secure and enclosable space for a recreational vehicle, and many vehicle related features are provided therein to allow the user to perform cleaning, maintenance, repair, etc. Various example embodiments of the present general inventive concept provide lodging accommodations for automobiles, boats, or other recreational vehicles that allow secure and private parking for guests of the lodge. While various example embodiments of the present general inventive concept provide a boat friendly fishing lodge accommodation designed for fishermen, a host of other types of guests and their recreational equipment who have need for the security of their equipment are also accommodated. With accommodations designed according to various embodiments of the present general inventive concept, guests can enjoy the peace of mind that comes with knowing that their assets are locked up in their own private garage, safe and sound. In various example embodiments the garage spaces may be separated from the lodge accommodations, but in other various example embodiments the garage spaces may be integrated with the lodge. For example, in one example embodiment the garage space may be located directly under the owner/guest's room, providing easy and convenient access to the garage. Such garages may be over-sized, so that the guest may have plenty of room around their boats or other vehicles to re-rig, clean, detail, etc., with relative ease and convenience. The garage spaces may be configured to be accessed by only the guest assigned to the space, for privacy and complete security. Various example embodiments may provide multiple power outlets for boats, electronics, or other equipment. One or more backup generators may be provided to back up the power outlets in case of a power outage. The garage spaces may have overhead lighting and one or more heaters to make the guest comfortable when working in the garage space. Drying stations may be provided on which to hang boat covers, rain suits, or other such gear. Water spigots and hoses may be provided for boat or truck washing. In some example embodiments fuel pumps may be provided so that the boat user can easily fuel the boat, and electric charging stations may also be provided.

In various example embodiments the garage spaces according to the present general inventive concept may be configured for boats, or for automobiles, or to accommodate both. In the descriptions herein all such vehicles may be referred simply as vehicles, which may include recreational and otherwise utilitarian modes of transportation. In some example embodiments the garage door may be the only access to the garage space, but in other example embodiments the guest may also be able to access the garage space through a door opening to the interior of the lodge, and to which only that guest has security access. These and other features will be more clearly discussed in the following description of the drawings.

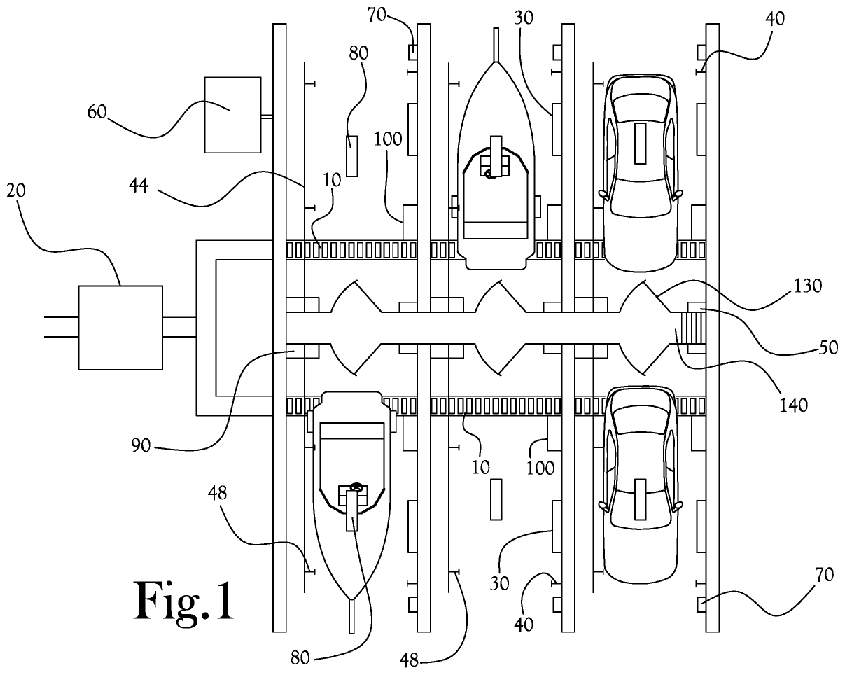

FIG. 1 illustrates a garage space system for lodge guests according to an example embodiment of the present general inventive concept. The garage system illustrated in FIG. 1 is configured for boats, but it is understood that some or all of the elements illustrated therein may be included for automobile garages, and also that garage spaces with such features may be configured to accommodate both boats and automobiles, as illustrated. While six vehicle spaces are illustrated in FIG. 1, it is understood that fewer or more spaces may be arranged in this or similar configurations in other various example embodiments of the present general inventive concept. As illustrated in FIG. 1, each of the vehicle spaces is configured with a trench drain 10 running therethrough to drain various liquids collecting on the floor through washing, general runoff, etc. For example, while boats may be washed in the garage spaces, there may also be runoff from boats used in more northern states that may be stored at night with ice or other frozen matter adhering to the hull, or from automobiles that have been driven in snow and ice. The vehicle spaces may have a first portion that slopes downward toward the trench drain 10 from one end of the space, and a second portion that slopes downward toward the trench drain 10 from the other end of the space. The trench drain 10 may be positioned towards the back of the bays, proximate to where boat hulls and live-wells can be drained into them. The trench drain 10 may run through each of the boat spaces and eventually to a water and oil separator 20 with a grit tank, which can be a commercial unit or design, such that oil and other impurities may be removed from the water before it is further drained to the environment or other collection space. Although a trench drain is illustrated and described herein, it is understood that other various drain configurations may be provided without departing from the scope of the present general inventive concept. Each of the vehicle spaces may have a wall heater 30, or other type of heater, installed therein to provide heat for the user during cold weather. The wall heather 30 may also be used for drying various articles, such as boat covers or garments, and thus a heater rack 32 may be installed in proximity to the wall heater 30 so that a user can hang the various articles near the wall heater 30 to dry. The heater rack 32 may be configured to decrease any chance of fire hazard when articles are hung thereon. It is noted that while some of the elements illustrated in FIG. 1 may only be shown in one space, such elements may be provided in each of the vehicle spaces, but may be omitted for clarity of the drawing. A water spigot 40, which may include an attached hose, may be provided in each vehicle space so that a user can clean the boat and other gear after a day of boating and fishing. A sprinkler system 44 having sprinkler heads 48 may be provided in each of the boat bays for fire control.

A charging station 50 may be provided so that a user can charge electric outboard engines or other such equipment. Each of the vehicle spaces (garages) may include one or more electrical outlets 58, and a backup generator 60 may be provided to be in electrical communication with the charging stations 50 and outlets 58 and other electrical fixtures so that they can still be used during power outages. In various example embodiments the charging stations 50 may include one or more outlets configured to charge devices such as the trolling motor and other batteries on the boat, which are wired directly in to prevent overload tripping of the breakers and also wired to the backup generator 60, and one or more outlets to charge newer big electric outboard motors and so on. Each of the boat spaces may include a fishing line receptacle 70 so that anglers can safely dispose of used fishing line. An overhead air charging station 80 may also be provided in each of the spaces for the convenience of the guest.

The vehicle or garage spaces illustrated in FIG. 1 may also include vehicle wash stations 90 provided so that a guest can wash their automobile or boat or jet skis or other vehicle, electric vehicle charging stations 100 so that a guest can conveniently charge their electric automobile during their stay. The garage of this example embodiment also includes interior doors 130 that lead from the garage spaces to the interior hallway garage entrance 140. Thus, guests can access their garage space without having to open the garage door. In various example embodiments a guest may be able to exit the lodge unit directly into the hall, go downstairs into the hallway garage entrance 140, and then in the interior door 130 to access his or her vehicle without having to go outside at all, and can perform cleaning or maintenance operations in relative comfort and privacy.

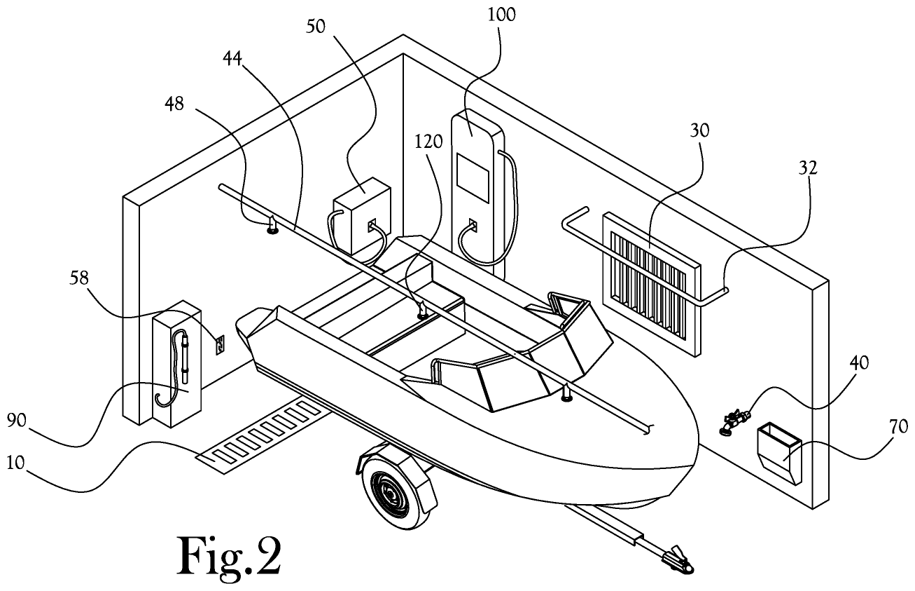

FIG. 2 illustrates a perspective view of a portion of a garage space according to an example embodiment of the present general inventive concept. The garage space illustrated in FIG. 2 is essentially the same as those illustrated in FIG. 1, except there is no interior door 130 in this example embodiment. Also, the interior lighting and garage doors themselves are not illustrated in several drawings herein for the sake of clarity. As illustrated in FIG. 2, a boat has been placed in the garage space, with the rear end of the boat positioned over the trench drain 10 for convenient drainage. In this position, the boat is in close proximity to the wash station 90, the charging station 50, the water spigot 40, and so on. As illustrated, the heater rack 32 may also serve to guard against a user getting too close to the wall heater 30.

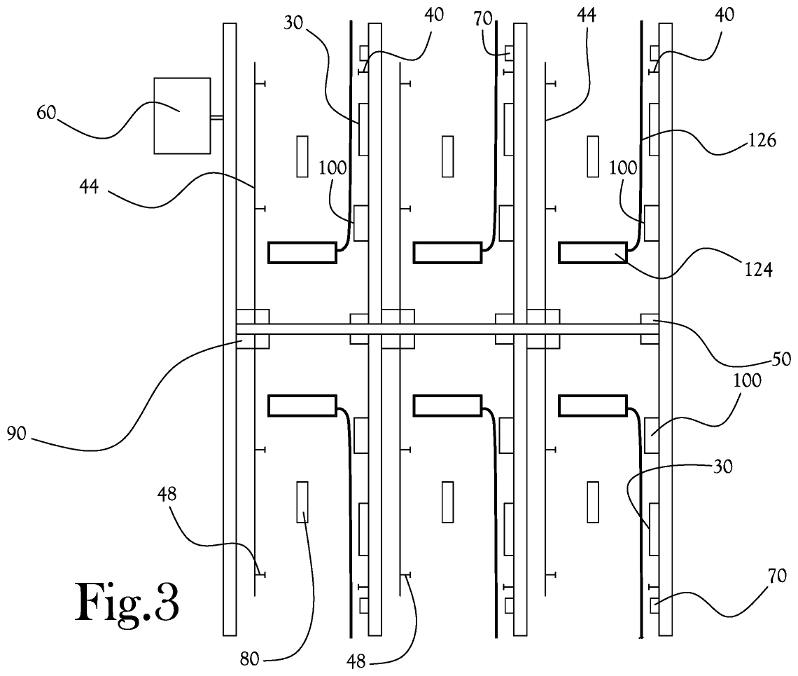

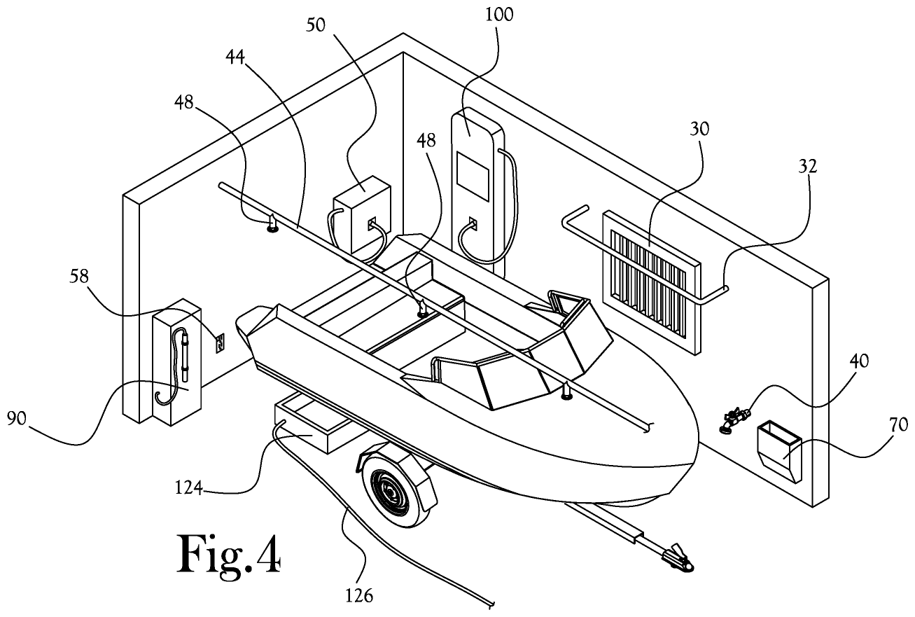

FIG. 3 illustrates a garage space system for lodge guests according to another example embodiment of the present general inventive concept. In this example embodiment, while many of the features of the garage spaces are the same, no trench drain has been included. Thus, to provide a convenient way to collect fluids that may be coming out of a boat or another vehicle, a portable drain basin 124 is provided that is positionable below the drainage area of a boat or other vehicle. FIG. 4 illustrates a perspective view of a portion of one of the garage spaces illustrated in FIG. 3, and shows the portable drain basin 124 in more detail. The portable drain basin 124 of this example embodiment may be provided with wheels (not shown) mounted underneath to make it easy for a user to move the drain basin 124. In this example embodiment the portable drain basin 124 is in the form of a box with an open top, and has a drain basin hose 126 that passes through to the interior of the portable drain basin 124 to allow the draining of the fluids collected therein to a point outside the garage space. In various example embodiments the drain basin may be configured to be non-portable, and may be placed to stay in one position and simply be emptied by the hose.

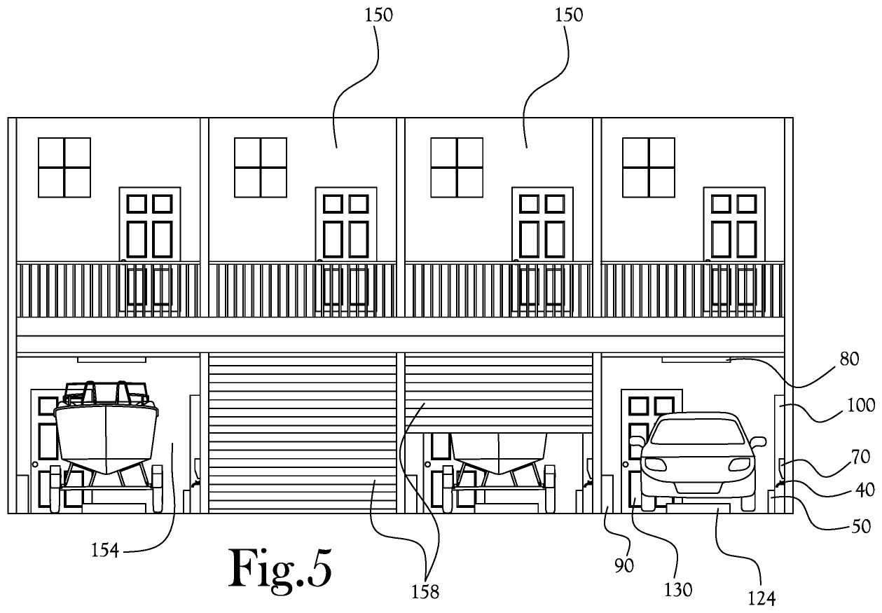

In various example embodiments the garage space system according to the present general inventive concept may be attached or detached from the lodge itself, and may be formed in continuous or disconnected units. FIG. 5 illustrates a garage space system attached to a lodge according to an example embodiment of the present general inventive concept. As illustrated in FIG. 5, each of the garage spaces 154 is configured to be directly below the corresponding lodge unit 150 of the renter, and thus the renter can keep close tabs on the garage space and the vehicle/equipment located inside. A garage door 158 is shown as closed and secured on one of the spaces, and partially closed in the other. In various example embodiments the user is able to enter the garage space through the interior door 130 without having to step outside at all.

As will be understood by the included drawings and features described herein, a hotel/motel/lodge guest can enjoy the peace of mind that comes with a secure garage space that allows the guest to leave fishing and other equipment on a boat or other vehicle without worry of theft. The guest can also enjoy many amenities included in the garage spaces, such as washing the boat/vehicle, charging, and so on.

Various example embodiments of the present general inventive concept may provide a garage space system for lodge guests, the system including one or more enclosable garage spaces each having a securable garage door, a drainage portion configured to drain liquid out of the one or more garage spaces, and a water supply configured to supply water for washing vehicles inside the respective one or more garage spaces. The drainage portion may include a portable basin configured to be placed under a desired area of a vehicle to capture runoff liquid therein. The portable basin may include a plurality of wheel members disposed on an underside thereof. The portable basin may include a drain hose configured to selectively allow liquid captured in the drainage portion to be release therethrough. The drainage portion may include a trench drain configured across a floor of the one or more enclosable garage spaces. The trench drain may be continuous across a plurality of the one or more enclosable garage spaces. The system may further include a water and oil separation system in fluid communication with the trench drain. The water and oil separation system may include a grit tank. A floor of the enclosable garage space may be sloped toward the trench drain on at least one side of the trench drain. The system may further include a sprinkler system including at least one sprinkler head in each of the one or more garage spaces. The system may further include a heating unit installed in the one or more enclosable garage spaces. The system may further include a hanging rack configured near the heating unit such that a user can hang articles near the heating unit for drying. The one or more enclosable garage spaces may each include an electrical charging station installed therein and configured to charge electric vehicles. The system may further include a backup generator configured to provide electricity to the one or more enclosable garage spaces. The system may further include an additional doorway provided to the one or more enclosable garage spaces to provide garage space access other than the securable garage door. The additional doorway may open to an indoor portion of a lodge to which the system is attached. At least a plurality of the one or more enclosable garage spaces may be configured directly below a corresponding lodge room. At least a plurality of the one or more enclosable garage spaces may share a wall with at least one other of the one or more enclosable garage spaces. The system may further include an additional doorway provided to the plurality of the one or more enclosable garage spaces to provide garage space access other than the securable garage door. The additional doorway of each of the plurality of the one or more enclosable garage spaces may open to a common hallway of a lodge to which the system is attached.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment. Numerous variations, modification, and additional embodiments are possible, and, accordingly, all such variations, modifications, and embodiments are to be regarded as being within the spirit and scope of the present general inventive concept.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. A garage space system for lodge guests, the system comprising:
one or more enclosable garage spaces each having a securable garage door;
a drainage portion configured to drain liquid out of the one or more garage spaces; and
a water supply configured to supply water for washing vehicles inside the respective one or more garage spaces.

2. The system of claim 1, wherein the drainage portion comprises a portable basin configured to be placed under a desired area of a vehicle to capture runoff liquid therein.

3. The system of claim 2, wherein the portable basin includes a plurality of wheel members disposed on an underside thereof.

4. The system of claim 2, wherein the portable basin includes a drain hose configured to selectively allow liquid captured in the drainage portion to be release therethrough.

5. The system of claim 1, wherein the drainage portion comprises a trench drain configured across a floor of the one or more enclosable garage spaces.

6. The system of claim 5, wherein the trench drain is continuous across a plurality of the one or more enclosable garage spaces.

7. The system of claim 5, further comprising a water and oil separation system in fluid communication with the trench drain.

8. The system of claim 7, wherein the water and oil separation system includes a grit tank.

9. The system of claim 5, wherein a floor of the enclosable garage space is sloped toward the trench drain on at least one side of the trench drain.

10. The system of claim 1, further comprising a sprinkler system including at least one sprinkler head in each of the one or more garage spaces.

11. The system of claim 1, further comprising a heating unit installed in the one or more enclosable garage spaces.

12. The system of claim 11, further comprising a hanging rack configured near the heating unit such that a user can hang articles near the heating unit for drying.

13. The system of claim 1, wherein the one or more enclosable garage spaces each include an electrical charging station installed therein and configured to charge electric vehicles.

14. The system of claim 1, further comprising a backup generator configured to provide electricity to the one or more enclosable garage spaces.

15. The system of claim 1, further comprising an additional doorway provided to the one or more enclosable garage spaces to provide garage space access other than the securable garage door.

16. The system of claim 15, wherein the additional doorway opens to an indoor portion of a lodge to which the system is attached.

17. The system of claim 1, wherein at least a plurality of the one or more enclosable garage spaces is configured directly below a corresponding lodge room.

18. The system of claim 1, wherein at least a plurality of the one or more enclosable garage spaces share a wall with at least one other of the one or more enclosable garage spaces.

19. The system of claim 18, further comprising an additional doorway provided to the plurality of the one or more enclosable garage spaces to provide garage space access other than the securable garage door.

20. The system of claim 15, wherein the additional doorway of each of the plurality of the one or more enclosable garage spaces opens to a common hallway of a lodge to which the system is attached.
